(19) United States
(12) Patent Application Publication
(10) Pub. No.: US 2005/0272308 A1
(43) Pub. Date: Dec. 8, 2005

(54) Electrical connector with improved board lock

(75) Inventors: Wei-Hua Pan, Kunsan (CN); Zhi-Qiang Li, Kunsan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/028,030

(22) Filed: Dec. 31, 2004

(30) Foreign Application Priority Data
Jun. 4, 2004 (CN) 2004200277139

(51) Int. Cl. H01R 13/66

(52) U.S. Cl. 439/567

(57) ABSTRACT

An electrical connector adapted for mounting on a Printed Circuit Board (PCB), comprises an insulative housing, a plurality of terminals loaded in the insulative housing and a board lock device assembled in the insulative housing. The insulative housing comprises a base portion having a PCB mounting face and a mating portion extending from the base portion. The base portion defines a boardlock-receiving cavity and is formed with a block adjacent to the cavity. The board lock device comprises a retaining plate retained in the cavity and substantially parallel to the PCB mounting face of the base portion and a lock plate perpendicularly extending from the retaining plate beyond the PCB mounting face of the base portion for locking with the PCB. The retaining plate is supported by the block for preventing the board lock device from moving along a direction perpendicular to the PCB mounting face of the base portion.

### BACKGROUD OF THE INVENTION

1. Field of the Invention

The present invention relates to an electrical connector, and more particularly to an electrical connector having a board lock for mounting the electrical connector on a surface of a printed circuit board.

2. Description of the Prior Art

Generally, an electrical connector is mounted onto a Printed Circuit Board (PCB) for signal transmission. Fastening means are provided for securing a housing of the electrical connector to the PCB to afford strain relief to prevent inadequate engagement of terminals of the electrical connector with the PCB, breaking of solder interfaces between the terminals and the PCB, and/or inadequate engagement of the terminals with mating terminals of another complementary connector mated to the electrical connector. Such means often are called “boardlocks” projecting from an engaging face of the housing into holes in the PCB.

U.S. Pat. No. 5,244,414 discloses a conventional board lock system. The board lock system comprises a boardlock-receiving cavity at one side of the housing with an open top at one side of an upper face of the housing and a boardlock device insertable into the open top of the cavity. However, in this configuration, the assembly difficulty of the boardlock device is increased as the engagement reliability between the boardlock device and the housing increased. In other word, in order to ensure the boardlock device to be reliably retained in the housing, the assembly of the boardlock device into the housing will require a large force. Furthermore, the large force during assembling the boardlock device might result in the housing to be destroyed.

Hence, an improved board lock device of an electrical connector is desired to overcome the disadvantages of the prior art.

### SUMMARY OF THE INVENTION

Accordingly, an object of the present invention is to provide an electrical connector, and particularly to an electrical connector having an improved board lock device simply assembled into and reliably retained in an insulative housing thereof.

To achieve the above objects, an electrical connector adapted for mounting on a Printed Circuit Board (PCB), comprises an insulative housing, a plurality of terminals loaded in the insulative housing and a board lock device assembled in the insulative housing. The insulative housing comprises a base portion having a PCB mounting face and a mating portion extending from the base portion. The base portion defines a boardlock-receiving cavity and is formed with a block adjacent to the cavity. The board lock device comprises a retaining plate retained in the cavity and substantially parallel to the PCB mounting face of the base portion and a lock plate perpendicularly extending from the retaining plate beyond the PCB mounting face of the base portion for locking with the PCB. The retaining plate is supported by the block for preventing the board lock device from moving along a direction perpendicular to the PCB mounting face of the base portion.

Other objects, advantages and novel features of the invention will become more apparent from the following detailed description when taken in conjunction with the accompanying drawings.

### PRIEF DESCRIPTION OF THE DRAWINGS

FIG. 1 is an exploded perspective view of an electrical connector in accordance with the present invention;

FIG. 2 is an assembled perspective view of the electrical connector shown in FIG. 1, with a board lock device exploded; and

FIG. 3 is an assembled view of the electrical connector shown in FIG. 1.

### DETAILED DESCIPTION OF THE PREFERRED EMBODIMENT OF THE INVENTION

Reference will now be made to the drawings to describe the present invention in detail.

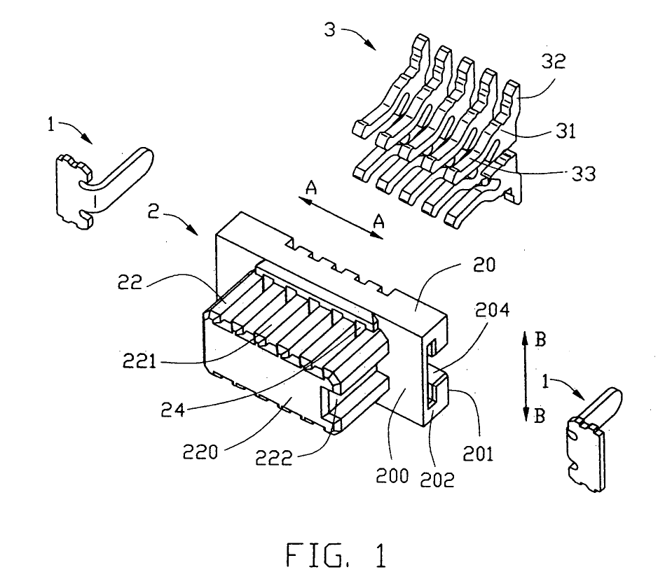

Referring to FIG. 1, an electrical connector of the present invention adapted for mounting onto a Print Circuit Board (PCB) (not shown) comprises a unitarily molded insulative housing 2, a plurality of terminals 3 assembled into the insulative housing 2, a board lock device 1 retained in the insulative housing 2 and adapted for mounting on a surface of the PCB.

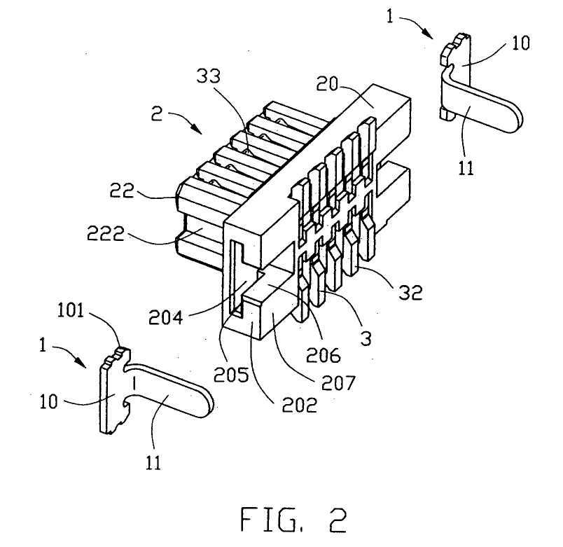

Referring to FIG. 1, the insulative housing 2 defines a longitude direction A and a transverse direction B perpendicular to the longitude direction. The housing 2 has an elongated base portion 20 and an elongated mating portion 22 projecting from an upper face 200 of the base portion 20. A plurality of passageways 24 is provided in the insulative housing 2 and is aligned in two lines along the longitude direction of the housing 2. Each passageway 24 extends from a PCB mounting face 201 of the base portion 20 toward a top face 220 of the mating portion 22 and is partially exposed in a side face 221 of the mating portion 22. In conjunction with referring to FIG. 2, the terminals 3 are loaded into the insulative housing 2 from the PCB mounting face 201 of the base portion 20. Each terminal 3 is provided with a retaining section 31 reliably fitted the terminal 3 in corresponding passageway 24, a contact section 33 extending from an upper end of the retained section 31 and exposed into the side face 221 of the mating portion 22, and a solder section 32 extending from an lower end of the retaining section 31 and exposed in the PCB mounting face 201 of the base portion 20 for electrically connecting a corresponding pad disposed in the PCB. A pair of guiding slot 222 is provided at opposite longitude ends for guiding the mating of a complementary connector (not shown), respectively.

Referring to FIGS. 1 and 2, the base portion 20 is configured with a pair of boardlock-receiving cavities 204 in opposite longitude side faces 202 thereof, respectively. The cavity 204 has a parallel section 205 substantially parallel to the PCB mounting face 201 of and a vertical section 206 communicating with the parallel section 205 and passing throughout the PCB mounting face 201 of the base portion 20. A pair of blocks 207 is provided on the base portion 20 and extends into the cavity 204 by configuring a dimension of the parallel section 205 to be larger than a dimension of the vertical section 206 along the transverse direction B of the housing 2.

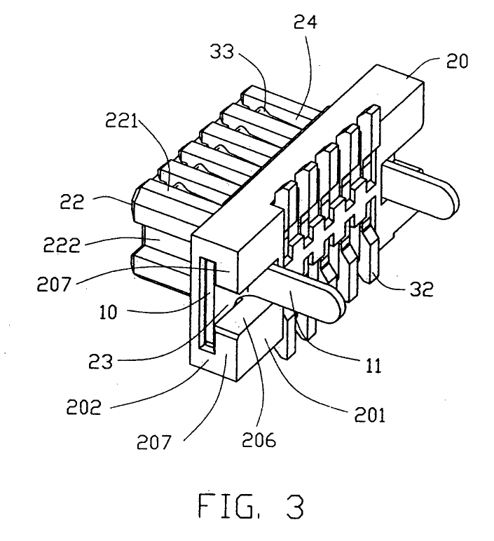

Referring to FIGS. 2 and 3, the board lock device 1 has a pair of board lock members, which is formed and stamped from a metal sheet, loaded from the side face 202 of the base portion 20 into the boardlock-receiving cavities 204 along the longitude direction A of the housing, respectively. Each board lock member comprises a retaining plate 10 snugly received in the parallel section 205 and supported by the blocks 207 of the base portion 20 for reliably preventing the board lock member from moving vertically. The retaining plate 10 is formed with a plurality of retaining bars 101 at opposite transverse edges thereof engaging with inner walls of the parallel section 205. A lock plate 11 perpendicularly extends from an inner longitude edge of the retaining plate 10 adjacent to the terminals 3 and pass through the vertical section 206 beyond the PCB mounting face 201 of the base portion 20 for mounting on the PCB. The lock plate 11 is configured in a plane-shape member, which defines a plane perpendicular to the longitude direction A of the housing 2 for reliably fasten the electrical connector onto the PCB along the transverse direction B.

While a preferred embodiment in accordance with the present invention has been shown and described, equivalent modifications and changes known to persons skilled in the art according to the spirit of the present invention are considered within the scope of the present invention as defined in the appended claims.

1. An electrical connector adapted for mounting on a Printed Circuit Board (PCB), comprising:
an insulative housing comprising a base portion having a PCB mounting face, and a mating portion extending from the base portion, the base portion defining a boardlock-receiving cavity and being formed with a block adjacent to the cavity;
a plurality of terminals loaded in the insulative housing; and
a board lock device comprising a retaining plate retained in the cavity and being substantially parallel to the PCB mounting face of the base portion, and a lock plate substantially perpendicularly extending from the retaining plate beyond the PCB mounting face of the base portion for locking with the PCB, the retaining plate being supported by the block for preventing the board lock device from moving along a direction perpendicular to the PCB mounting face of the base portion.

2. The electrical connector as claimed in claim 1, wherein the boardlock-receiving cavity open in a side face of the base portion perpendicular to the PCB mounting face.

3. The electrical connector as claimed in claim 2, wherein the insulative housing defines a longitude direction along which the terminals are arranged in lines, and wherein the lock plate defines a plane perpendicular to the longitude direction of the insulative housing.

4. The electrical connector as claimed in claim 3, wherein the board lock device is assembled into the insulative housing along the longitude direction.

5. The electrical connector as claimed in claim 3, wherein the lock plate extends from a longitude edge of the retaining plate adjacent to the terminals.

6. The electrical connector as claimed in claim 1, wherein the boardlock-receiving cavity has a vertical section passing through the PCB mounting face of the base portion for receiving the lock plate.

8. The electrical connector as claimed in claim 1, wherein the mating portion defines a guiding slot.

9. The electrical connector as claimed in claim 1, wherein the retaining plate is formed with a plurality of retaining bars for interferentially engaging with the insulative housing.

10. The electrical connector as claimed in claim 1, wherein the board lock device comprises a pair of board lock member disposed opposite longitude ends of the base portion, respectively.

11. An electrical connector comprising:
an insulative housing defining a lengthwise axis;
a plurality of contacts disposed in the housing;
a pair of cavities formed at two ends of a bottom portion of the housing, each of said cavities defining a T-shaped cross-sectional configuration which communicatively faces toward an exterior in a first direction along said lengthwise axis; and
a pair of board locks each defining a horizontal retaining plate and a vertical lock plate respectively received in a corresponding horizontal section and a vertical section of said T-shaped cross-sectional configuration; wherein
said board lock is horizontally assembled to the corresponding cavity in a second direction opposite to said first direction, and the lock plate extends from an inner edge of said retaining plate.
